(19) United States
(12) Patent Application Publication
(10) Pub. No.: US 2009/0052717 A1
(43) Pub. Date: Feb. 26, 2009

(54) SOLAR PANEL WITH BLUETOOTH EARPHONE

(75) Inventor: Fan Wei CHI, Taipei City (TW)

Correspondence Address: WPAT, PC, 7225 BEVERLY ST., ANNANDALE, VA, 22003, US

(73) Assignee: Fan Wei CHI, Taipei City (TW)

(21) Appl. No.: 12/184,503

(22) Filed: Aug. 1, 2008

(30) Foreign Application Priority Data
Aug. 22, 2007 (TW) 096213987

(51) Int. Cl. H04R 1/10

(52) U.S. Cl. 381/380

(57) ABSTRACT

An solar panel with bluetooth earphone connects with a handhold communicated apparatus. The solar panel with the bluetooth earphone comprises: an earphone, a supplying-saving power part, a cover, a solar part, a sounder and a reception part. The earphone has a topside, a bottom side, and a container. The cover is above the topside that has a hole. The solar part that accepts an optical energy that transforms an electric power is above the hole. The supplying-saving power part that electrically connects with the solar power to save the electric power is inside the container. The sounder that connects with the supplying-saving power part electrically is above the bottom side. The sounder is sent a ring signal by the electric power. The sounder that electrically connects with the supplying-saving power part is above the bottom side. The sounder accepts an audio signal by the electric power.

### BACKGROUND OF THE INVENTION

1. Field of the Invention

The present invention relates to bluetooth earphone, more particularly it has a solar panel, which charges the earphone to increase the time of the bluetooth earphone.

2. Description of the Prior Art

Referring to FIG. 3 is the three-dimensional drawing of the bluetooth earphone in accordance with a prior art. The bluetooth earphone includes an earphone 31, a battery 32, a reception part 33, and a sounder 34 and a charge hole 35. The earphone 31 has a bottom side 311 and a side 312. The side 312 connects with the bottom side 311. The battery 32 is electrically set in the earphone 31 due to providing an operational power for the earphone 31. The battery 32 is a dry battery, a lithium battery or any one of the charge batteries. The reception part 33 and the sounder 34 are above the bottom side 311. As the earphone 31 is operating, the reception part 33 accepts an audio voice and then the sounder 34 sends a voice. The charge hole 35 that electrically connects with the battery 32 is above the side 312. The charge hole 35 that connects with electrical apparatuses is charging to the battery 32.

Then, the time consuming of the bluetooth earphone is following the capacity measure of the battery. While the battery capacity is bigger, the time consuming of the bluetooth earphone is longer. However, the volume of the battery is coming bigger size. The small volume of the battery as result of the time consuming is shortened. For all that, the bluetooth needs to prepare the battery charger anytime. That loses the advantage of a light and handy hold function for the bluetooth.

In view of the shortcomings of the prior art, the inventor of the present invention based on years of experience in the bluetooth to conduct experiments and modifications, and finally developed a solar panel with a bluetooth to overcome the foregoing shortcomings.

### SUMMARY OF THE INVENTION

The primary objective of the present invention is to provide a solar panel with bluetooth earphone. The surface of the earphone has the solar panel. The solar panel absorbs the light energy to transform the electric energy, which saves the battery. It increases the time of the battery of the bluetooth.

The present invention provides a solar panel with bluetooth earphone. A transmission line of the electric power connects with an electric apparatus to charge the electric power for convenient effect.

The present invention provides a solar panel with bluetooth earphone, which connects with a handhold communicated apparatus. The solar panel of the bluetooth earphone at least comprises: an earphone, a supplying-saving power part, a cover, a solar part, a sounder and a reception part. The earphone has a top side, a bottom side and a container. The cover that has a hole is above the topside. The solar part that accepts a light energy to transform an electric power is above the hole. The supplying-saving power part that connects with the solar part to save the electric power is inside the container. The sounder that electrically connects with the supplying-saving power part to send a ring signal is above the bottom side. The reception part that electrically accepts a voice signal is above the bottom side.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1A is a three-dimensional decomposition view of the solar panel of the bluetooth earphone in accordance with the present invention.

FIG. 1B is a vertical view of the solar panel of the bluetooth earphone in accordance with the present invention.

FIG. 1C is a right side view of the solar panel of the bluetooth earphone in accordance with the present invention.

FIG. 2A is a flow chart of the solar panel of the bluetooth earphone connects with the cellular phone in accordance with the present invention.

FIG. 2B is a flow chart of the solar panel of the bluetooth earphone connects with the electrical apparatus in accordance with the present invention.

FIG. 3 is a the three-dimensional drawing of the bluetooth earphone of in accordance with the prior art

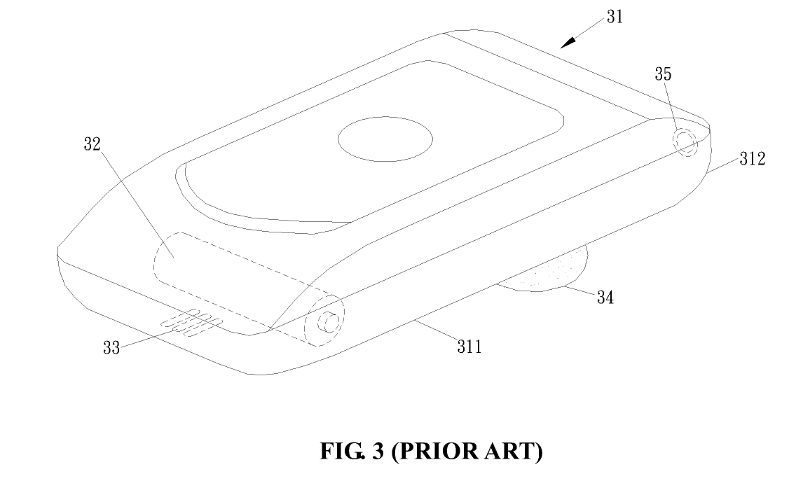

### DETAILED DESCRIPTION OF THE PREFERRED EMBODIMENTS

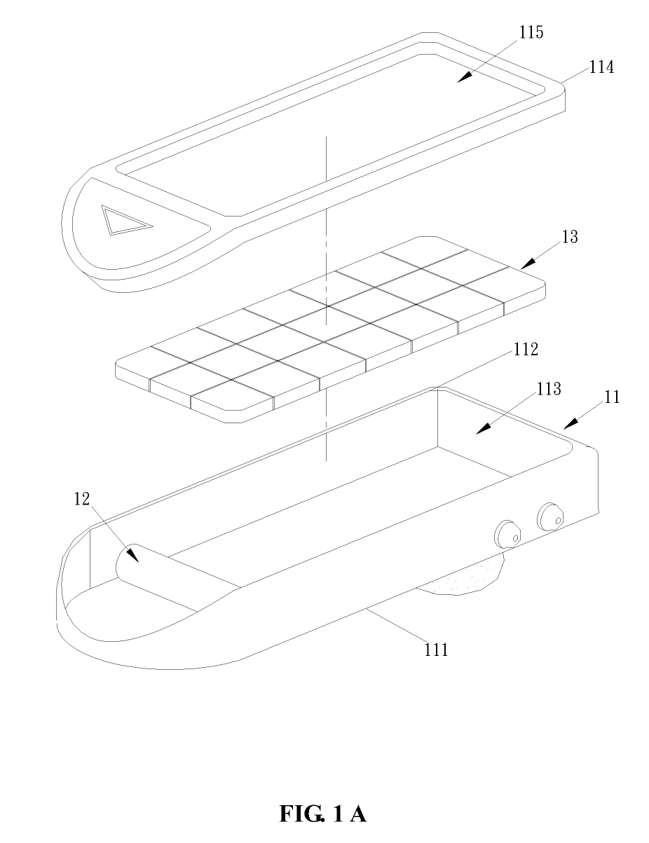

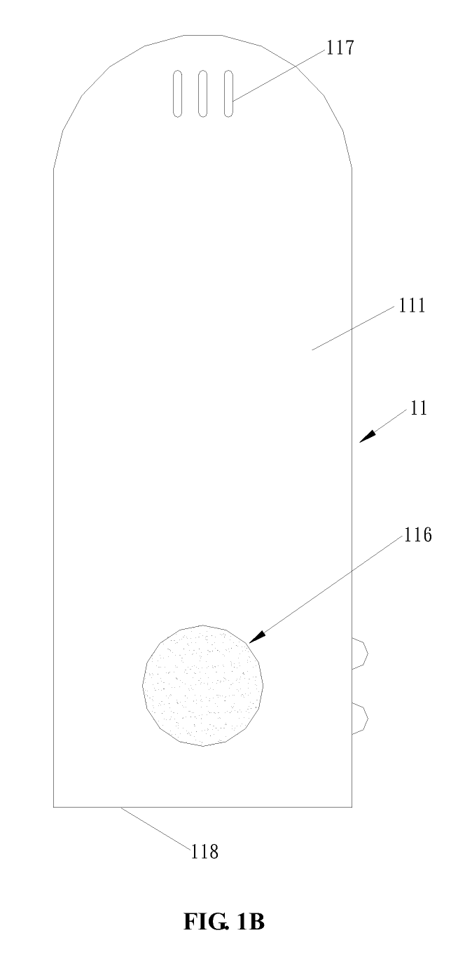

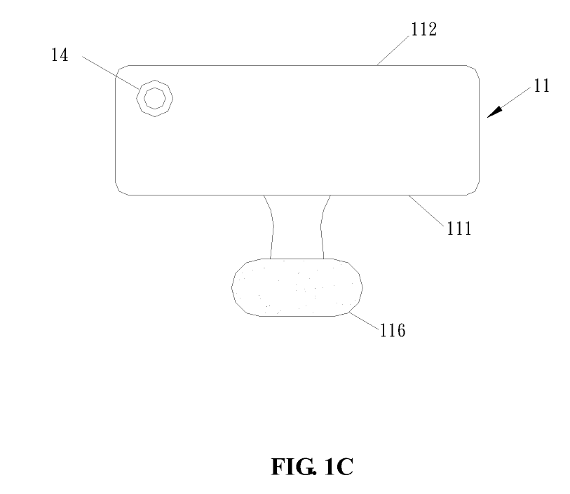

In the related figures of a preferred embodiment, the same referring numerals are used for the same components of an input apparatus in accordance with the present invention. Referring to FIG. 1A to 1C for a three-dimensional decomposition view of the solar panel with the bluetooth earphone, a vertical view of the solar panel with the bluetooth earphone and a right side vertical view of the solar panel with the bluetooth earphone. The solar panel with the bluetooth earphone at least includes an earphone 11, a supplying-saving power part 12 and a solar part 13. The earphone 11 is relative a bottom side 111 and the top side 112. The bottom side 111 and the top side 112 becomes a container 113.

The earphone 11 has a cover 114 that has a hole 115 is above the top side 112. The hole 115 contains the solar part 13. The supplying-saving power part 12 is a dry battery, a lithium battery or any one of the charge batteries. The supplying-saving power part 12 that electrically connects with the earphone 11 is inside the container 113. The supplying-saving power part 12 saves an electric power to release the saving electric power, which provides the electric energy to operate the earphone 11.

The solar part 13 is made by a solar panel. The solar part 13, which connects the outside, is set the topside 112. The solar part 13 electrically connects with the supplying-saving power part 12. When the sunlight or the light shines the solar part 13, the solar part 13 can make an electric power. Therefore, the electric power conducts to the supplying-saving power part 12 for power saving.

The bottom side 111 of the earphone 11 has a sounder 116 and a reception part 117. The sounder 116 is better to be a speaker that is into the user ear. The reception part 117 is better to be a microphone. Therefore, the earphone 11 is operating by the above-mentioned propose about the electrical power operation; the sounder 116 makes an audio voice. The user hears the audio voice. In addition, the earphone 11 has the bottom side 111 connects a side 118, which has a charger hole 14. The charger hole 14 electrically connects with the supplying-saving part 12. As the charger hole 14 electrically connects with a charger (non-shown), the supplying-saving power part 12 processes a charging operation. The present invention is relative to the solar panel with the bluetooth earphone to combine the functions such as the MP3 speaker, radio speaker and the USB flash drive.

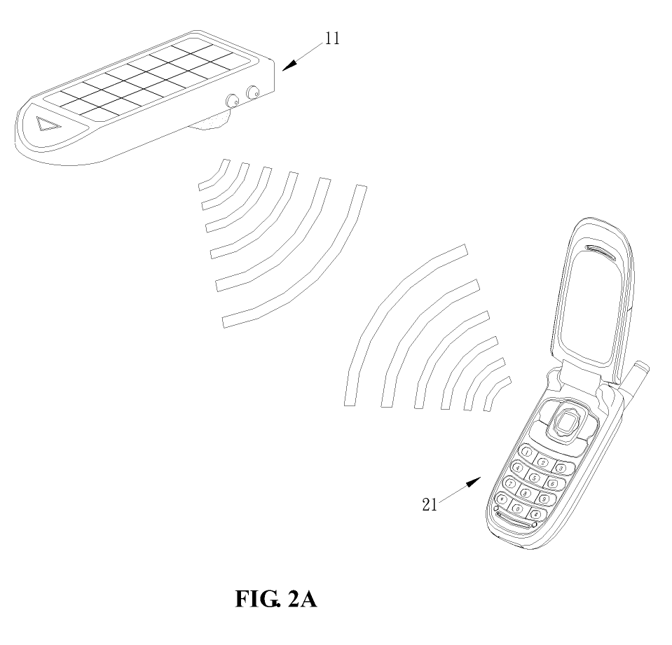

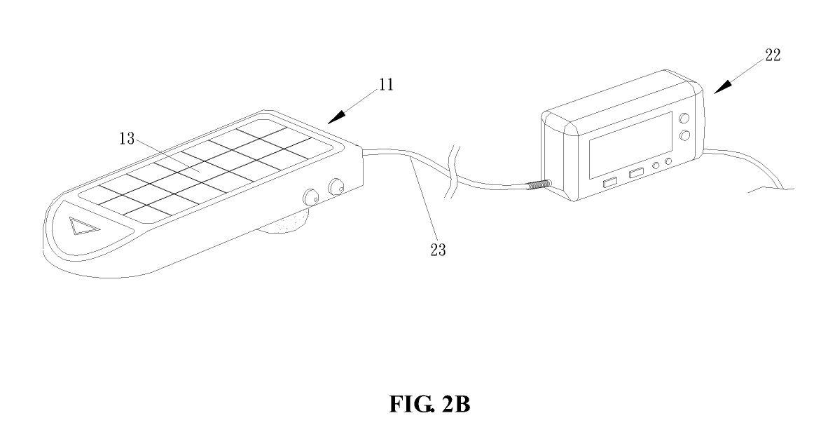

Referring to three-dimensional FIG. 2A to FIG. 2B for the present invention the solar panel of the bluetooth is a better embodiment. The below embodiment is according to symbols and numbers of the previous embodiment. The present invention is relative to the bluetooth earphone 11 is suitable for use a handy hold communicated apparatus 21. This better embodiment is relative to the handy hold communicated apparatus 21 such as a cellular phone. As the earphone 11 switch on, the earpohone 11 connects with the cellular phone21. Furthermore, the earphone 11 electrically connects with an electric apparatus 22(for example: MP3 furthermore 22) by a transmission line 23. The solar part 12 has the power to charge the electric apparatus 22.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An solar panel with bluetooth earphone, comprising:
a earphone having a topside, a bottom side and a container;
a cover, located at the topside above, having a hole;
a solar part, located at the hole above, can receive a light energy to transform a electric power;
a supplying-saving power part, located at the container and connected with the solar power electrically, saved the electric power;
a sounder, located at the bottom side above and connected with the supplying-saving power part electrically, sent a ring voice by the electric power; and
a reception part, located at the bottom side above and connected with the supplying-saving power part electrically, accepted an audio signal by the electric power.

2. The solar panel with bluetooth earphone of claim 1, wherein the supplying-saving power part is a dry battery.

3. The solar panel with bluetooth earphone of claim 1, wherein the supplying-saving power part is a lithium battery.

4. The solar panel with bluetooth earphone of claim 1, wherein the supplying-saving power part is a battery, the battery processes to charge and discharge.

5. The solar panel with bluetooth earphone of claim 1, wherein the solar party is a solar panel.

6. The solar panel with bluetooth earphone of claim 1, wherein the earphone further includes a charger hole, the charger hole electrically connects with the supplying-saving power part.

7. The solar panel with bluetooth earphone of claim 6, wherein solar panel with bluetooth earphone further includes a charger, the charger connects with the charge hole and charges the supplying-saving power part.

8. The solar panel with bluetooth earphone of claim 1, wherein the earphone connects with a handhold communicated apparatus.

9. The solar panel with bluetooth earphone of claim 1, wherein the solar part electrically connects with another solar part.

10. The solar panel with bluetooth earphone of claim 1, wherein the earphone electrically connects with an electrical apparatus, the electric power transforms to the electrical apparatus.
